(19) United States
(12) Patent Application Publication
(10) Pub. No.: US 2011/0223416 A1
(43) Pub. Date: Sep. 15, 2011

(54) Jig for gathering punched-out parts

(76) Inventors: Chiu-Yu Yeh, Taoyuan (TW); Wei-Liang Lin, Taoyuan (TW); Chia-Sheng Cheng, Taoyuan (TW)

(21) Appl. No.: 12/793,655

(22) Filed: Jun. 3, 2010

(30) Foreign Application Priority Data
Mar. 15, 2010 (TW) 099107463

(51) Int. Cl. B32B 7/12

(52) U.S. Cl. 428/343

(57) ABSTRACT

A jig includes a carrying plate and a temporary adhering layer on the carrying plate, for gathering parts for an assembly after the parts are punched out. The temporary adhering layer includes a temporary adhering material at its surface. The parts for an assembly temporarily adhere to the surface of the temporary adhering layer. The temporary adhering layer may further have impact buffering properties.

### BACKGROUND OF THE INVENTION

1. Field of the Invention

The present invention relates to a tool for gathering punched out parts, and particularly to a jig for gathering key-tops.

2. Description of the Prior Art

The technology for keypad structures of portable electric products such as mobile phones, PDA, electric dictionaries, remote controllers, in-house telephones, calculators, and the like is increasingly developed. Among these developments, keypad primary pieces are formed through the combination of the plastic material and the rubber material. The combination of the plastic material and the rubber material is mostly accomplished as follows. A plastic injection molding is carried out to form a key-top tree including a plurality of thin key-tops. The key-tops are printed to have figures for each key. The key-tops are punched off the key-top tree and moved and collected manually or by a tool to be placed on an assembly jig to be combined with the rubber material to form the keypad primary piece.

FIG. 1 illustrates an assembly jig 2, in which the place receives a punched out key-top 4 is in a dish shape. In order to keep the key-top 4 not to move or shake during a manufacturing process, there is a hole at the dish bottom for evacuation via a pipe 6 by a vacuum equipment to suck the key-top 4. However, a vacuum equipment will consume electric energy and be noisy. Furthermore, air flows upon evacuation, which tends to damage the surface of the key-tops. Moreover, when the punched-out key-tops are gathered to be placed in the dishes of the assembly jig, the key-tops easily shake due to air flow and the location of the key-tops in the dish can be wrongly shifted, such that the assembly precision is badly affected.

Therefore, there is still a need for a novel jig for gathering punched-out parts, which can also serve as an assembling jig, for saving energy and retaining each part in a precise position.

### SUMMARY OF THE INVENTION

One objective of the present invention is to provide a jig for gathering key-tops having temporary adhesive properties. It may further have impact buffering properties. Accordingly, it can be conveniently employed and electric energy can be saved.

A jig for gathering key-tops according to the present invention includes a carrying plate and a temporary adhering layer on the carrying plate, for gathering parts for an assembly after the parts are punched out. The temporary adhering layer includes a temporary adhering material at a surface thereof to allow the parts for the assembly to temporarily adhere to the surface of the temporary adhering layer.

In comparison with conventional techniques, in the jig for gathering key-tops according to the present invention, a temporary adhering material is employed to securely hold the punched-out parts for an assembly. When the parts for an assembly are removed from the jig, there is no residue of the temporary adhering material remaining on the parts for an assembly. Electric power is not needed for the adhesion. The locations of the parts for an assembly are precise. Furthermore, the temporary adhering layer may further provide impact buffer, which can minimize damage due to impact.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view of a conventional jig for gathering key-tops;

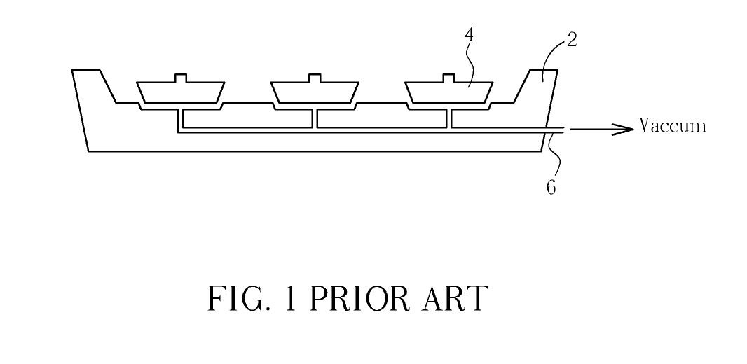

FIG. 2 is a schematic cross-sectional view of a jig for gathering key-tops according to an embodiment of the present invention;

FIG. 3 is a schematic cross-sectional view illustrating a temporary adhering layer according to an embodiment of the present invention;

FIG. 4 is a schematic cross-sectional view illustrating a status of a jig for gathering key-tops carrying key-tops according to an embodiment of the present invention;

FIG. 5 illustrates an application of a jig for gathering key-tops according to the present invention; and

FIG. 6 is a schematic cross-sectional view illustrating a situation that a key-top is punched out to arrive on the temporary adhering layer.

### DETAILED DESCRIPTION

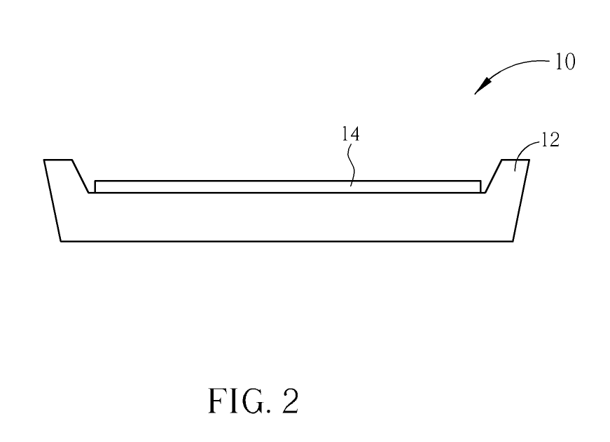

FIG. 2 shows an embodiment of the present invention. A jig for gathering key-tops 10 includes a carrying plate 12 and a temporary adhering layer 14 on the carrying plate 12, for receiving punched-out parts for an assembly. The temporary adhering layer includes a temporary adhering material at its surface. The parts for an assembly can temporarily adhere to the surface of the temporary adhering layer.

Herein, the term “temporarily adhere” means that the parts for an assembly can be stuck on a surface with a certain level of adhesion strength which allows the parts for an assembly not to move upon for example a shake, a vibration, or a quake, and allows the parts for an assembly to be well detached from the temporary adhering layer for a subsequent process. The term “to be well detached” means that there is no residue of the temporary adhering material remaining on the parts for an assembly and the parts for an assembly will not be hurt by the temporary adhering layer, such that the parts for an assembly can be completely and soundly detached from the temporary adhering layer.

The temporary adhering material may be for example a mixture of a silicone rubber and an adhesive, i.e., a mixture of a silicone polymer and an adhesive polymer. Such mixture is currently often employed in dust rollers (also referred to be as adhesive rollers), for example, silicone rubber, butyl rubber, synthetic rubber, common rubber, and the like, but not limited thereto. As long as a material has temporary adhesive properties and is not harmful to or damages the parts for an assembly or other components encompassed in the present invention, it is employable in the present invention.

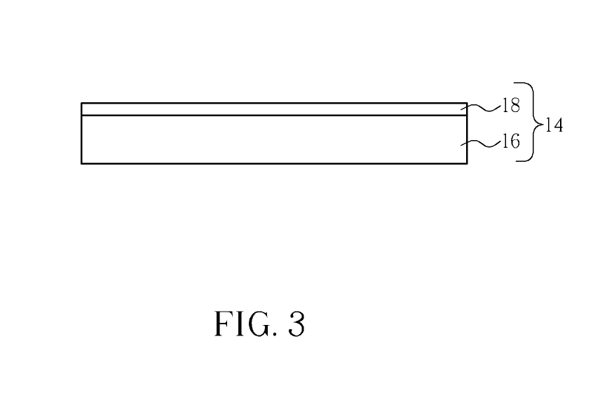

In the present invention, the temporary adhering layer may be composed of a temporary adhering material, or, as shown in FIG. 3, the temporary adhering layer 14 may further include a base layer 16, and a temporary adhering material 18 is placed on the base layer 16. The base layer may serve as a support for the temporary adhering material 18. The material for the base layer is not particularly limited as long as it possesses such function of temporary adhesion and is not harmful to the processes and the tools.

Alternatively, the temporary adhering layer 14 may further have an impact buffering properties to reduce or dissipate an impact force, so as to prevent the parts for an assembly from break.

The carrying plate 12 may be in a shape of plate or dish, but not limited thereto. The temporary adhering layer 14 and the carrying plate 12 may be combined permanently, and, after the parts for an assembly are placed thereon, work together for subsequent assembly operations. Alternatively, the temporary adhering layer 14 and the carrying plate 12 may be combined in a detachable way, i.e., the temporary adhering layer 14 can be removed from the carrying plate 12 for refill or with the parts for an assembly together for proceeding subsequent assembly operations.

The jig for gathering key-tops according to the present invention may be utilized in for example a keypad manufacturing process to receive punched-out key-tops. The parts for an assembly may be for example plastic, rubber, or metal, but not limited thereto.

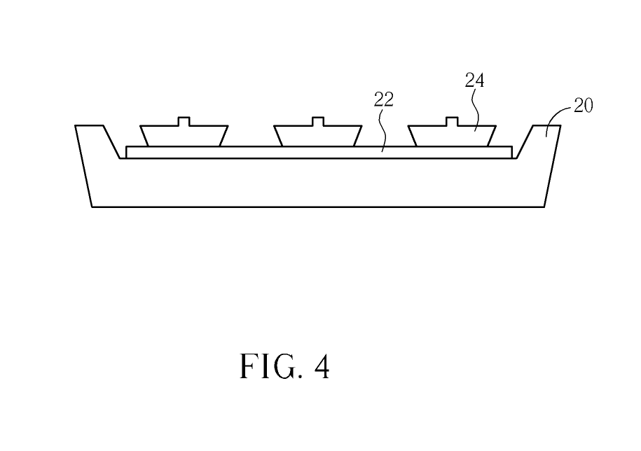

As shown in FIG. 4, a jig for gathering key-tops, including a dish-like carrying plate 20 and a temporary adhering layer 22, receives key-tops 24 which are punched out and reach the surface of the temporary adhering layer 22. Accordingly, the key-tops 24 temporarily adhere to the temporary adhering layer 22.

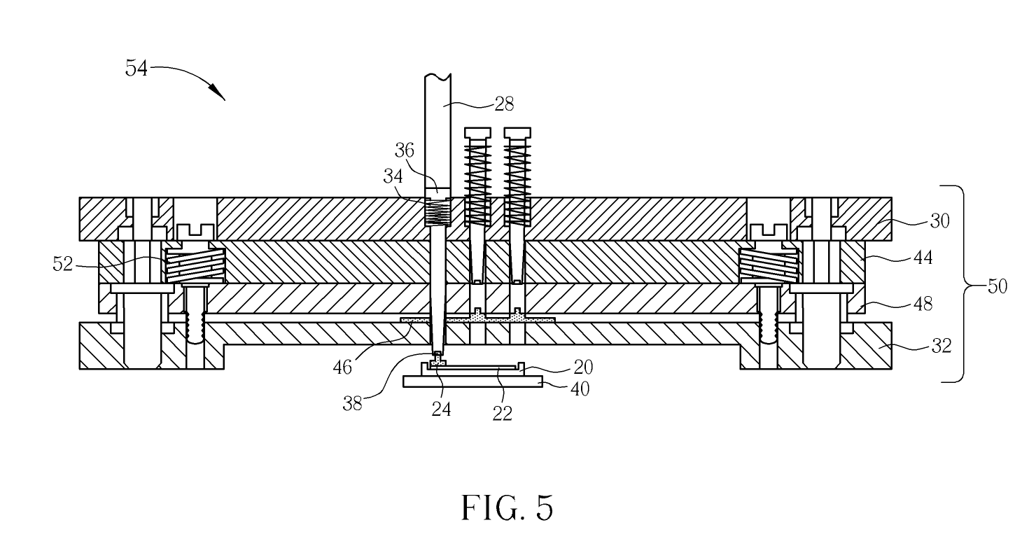

FIG. 5 illustrates an application of a jig for gathering key-tops according to the present invention, which is utilized in a punching operation in a keypad manufacturing process to serve as a jig for gathering the punched out key-tops. A gathering apparatus 54 is utilized to punch a key-top tree 46 and gather the key-tops. In detail, the key-top tree 46 is placed on a cutting die 32 of a punching die 50. After the cutting die 32, a top die 30, a guide plate 44, and a stripper 48 are closed, the punching die 50 is aligned. A receiving base 40 is placed under the punching die 50. A jig for gathering key-tops according to the present invention is placed on the receiving base 40. The jig for gathering key-tops includes a dish-like carrying plate 20 and a temporary adhering layer 22 on the carrying plate 20. The receiving base 40 is moved to a predetermined position for receiving a punched out key-top. A punch 28 is moved to be above a key-top in the key-top tree. When the punch 28 moves down to hit a strike pin 36, the strike pin 36 downwardly presses a spring 34. The strike pin 36 continues going down and passing the through hole to allow the punching pin 38 to hit the key-top tree 46, thereby the key-top 24 is cut out off the key-top tree 46 by the cutting die 32 and goes down with the punching pin 38 to reach a predetermined position on the carrying plate 20. The punch 28 goes up back to its original place after the punch, and, in the same time, the punching pin 38 also goes up back to its original place. In virtue of the spring device 52, the stripper 48 strips the key-top tree 46 off the punching pin 38. After the punch 28 arrives to its original position before the aforementioned punch, it is moved to the next key-top, and the receiving base 40 is moved to the next predetermined place, which in turn allows the carrying plate 20 to move to its next predetermined position for receiving the next punched out key-top. The punch and the gathering (or collection) are carried out in such way to provide a set of key-tops which are gathered on the jig of the present invention for a subsequent assembly process.

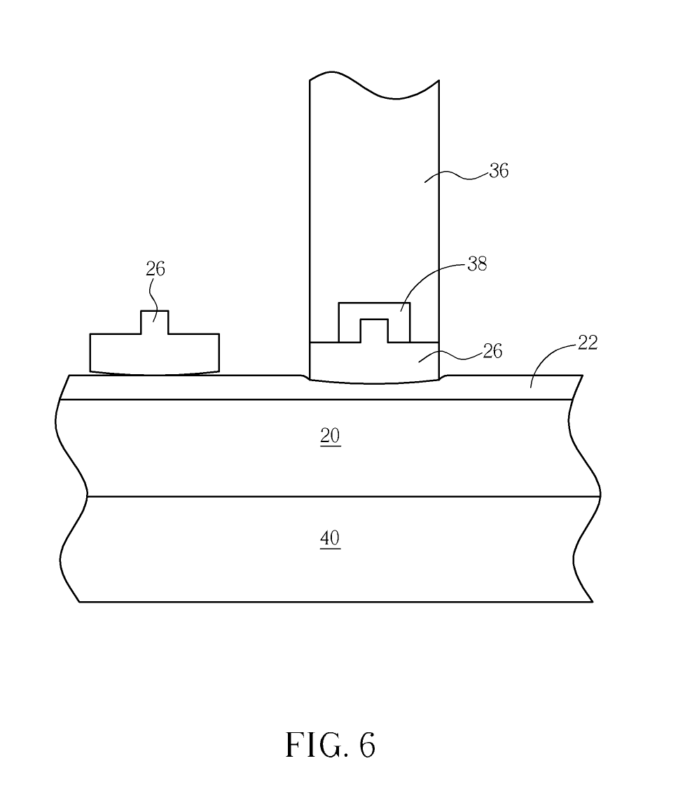

FIG. 6 is a schematic cross-sectional view illustrating a situation that a key-top is punched out to arrive on the temporary adhering layer. The temporary adhering layer 22 has impact buffering properties. When the strike pin 36 and the punching pin 38 punch out the key-top 26, the key-top 26 goes down with the punching pin 38 to hit the temporary adhering layer 22, such that a temporary recess forms on the temporary adhering layer 22 due to the impact buffering properties. In such way, the key-top can be protected from impact damage. Since the key-top 26 temporarily adheres to the temporary adhering layer 22, it is not shifted or moved by a punch carried out for an adjacent key-top, even though the key-top 26 may have a slightly curvy surface.

Those skilled in the art will readily observe that numerous modifications and alterations of the device and method may be made while retaining the teachings of the invention.

What is claimed is:

1. A jig for gathering key-tops, comprising:
a carrying plate; and
a temporary adhering layer on the carrying plate, for gathering parts for an assembly after the parts are punched out, wherein the temporary adhering layer comprises a temporary adhering material at a surface thereof to allow the parts for the assembly to temporarily adhere to the surface of the temporary adhering layer.

2. The jig of claim 1, wherein the temporary adhering layer is composed of the temporary adhering material.

3. The jig of claim 1, wherein, the temporary adhering layer comprises a base layer and the temporary adhering material is disposed on a surface of the base layer.

4. The jig of claim 1, wherein the temporary adhering layer further has properties of impact buffering.

5. The jig of claim 1, wherein the parts for an assembly comprise a plurality of key-tops.

6. The jig of claim 1 for use as an assembly jig in a keypad manufacturing process, wherein the parts for an assembly comprise key-tops.
